(19) United States
(12) Patent Application Publication
(10) Pub. No.: US 2018/0241644 A1
(43) Pub. Date: Aug. 23, 2018

(54) SERVER PERFORMANCE EVALUATION THROUGH SINGLE VALUE SERVER PERFORMANCE INDEX

(71) Applicant: MICROSOFT TECHNOLOGY LICENSING, LLC, Redmond, WA (US)

(72) Inventor: Lei Lu, Redmond, WA (US)

(73) Assignee: MICROSOFT TECHNOLOGY LICENSING, LLC, Redmond, WA (US)

(21) Appl. No.: 15/438,150

(22) Filed: Feb. 21, 2017

(51) Int. Cl. H04L 12/26; H04L 12/24

(52) U.S. Cl. CPC H04L 43/04; H04L 41/0813; H04L 43/16

(57) ABSTRACT

Technologies are described for evaluation of server performance through a single value SPI. Server performance dimensions to be used in overall server performance evaluation may be determined and monitored through continuous monitoring or sampling. The dimensions may include, but are not limited to, processor usage, memory usage, input/output usage, network usage, response time, latency, and similar parameters. A threshold value that identifies an average performance value for each dimension over a predefined time period may be determined for each dimension. A performance index may be determined for each dimension normalized by the corresponding threshold value. The SPI may be determined based on an averaging of the performance indices of the one or more dimensions and an alert or a report may be generated and/or a server operation may be adjusted based on an evaluation of the SPI.

### BACKGROUND

Distributed computing technologies have enabled multiple computing resources to provide coordinated or distinct solutions. An example of distributed computing, cloud computing brings together multiple systems to provide solutions to user needs. Cloud computing can span a vast array of computing resources. The computing resources utilized in cloud computing applications may be dispersed across networks and locations. Dispersed computing resources are remotely controlled and managed. Usually, automated systems monitor and troubleshoot problems associated with dispersed computing resources. Manual troubleshooting by human components of widely dispersed computing resources is not cost effective.

Conventional monitoring solutions for cloud computing systems performance have limitations. The amount of data generated by cloud computing systems is vast. Computing power necessary to analyze and produce performance metrics from the data is equally large. Conventional solutions typically rely on threshold based implementations. Such implementations are usually inflexible and rarely meet customer demands for redirecting servers to other purposes. Current monitoring implementations also frequently require human intervention to configure parameters and other values to maintain normalized operations.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to evaluation of server performance through a single value server performance index (SPI). In some examples, one or more server performance dimensions to be used in overall server performance evaluation may be monitored. A threshold value that identifies an average performance value for each dimension over a predefined time period may be determined for each dimension. Next, a performance index may be determined for each dimension normalized by the corresponding threshold value. The SPI may be determined based on an averaging of the performance indices of the one or more dimensions and an alert or a report may be generated and/or a server operation may be adjusted based on an evaluation of the SPI.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIGS. 1A-1B include display diagrams illustrating example network environments where evaluation of server performance through a single value server performance index (SPI) may be implemented;

FIG. 2 includes a display diagram illustrating an example scheme to implement evaluation of server performance through a single value SPI up to report and/or alert generation phases;

FIG. 3 includes a display diagram illustrating an example scheme to implement evaluation of server performance through a single value SPI including operational adjustment phases;

FIG. 4 is an example networked environment, arranged in accordance with at least some embodiments described herein;

FIG. 5 illustrates a general purpose computing device, which may be configured to provide evaluation of server performance through a single value SPI, arranged in accordance with at least some embodiments described herein; and

FIG. 6 illustrates a logic flow diagram for an example process to provide evaluation of server performance through a single value SPI.

### DETAILED DESCRIPTION

As briefly described above, embodiments are directed to evaluation of server performance through a single value SPI. Server performance dimensions to be used in overall server performance evaluation may be determined and monitored through continuous monitoring or sampling. The dimensions may include, but are not limited to, processor usage, memory usage, input/output usage, network usage, response time, latency, and similar parameters. A threshold value that identifies an average performance value for each dimension over a predefined time period may be determined for each dimension. A performance index may be determined for each dimension normalized by the corresponding threshold value. The SPI may be determined based on an averaging of the performance indices of the one or more dimensions and an alert or a report may be generated and/or a server operation may be adjusted based on an evaluation of the SPI.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide evaluation of server performance through a single value SPI. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

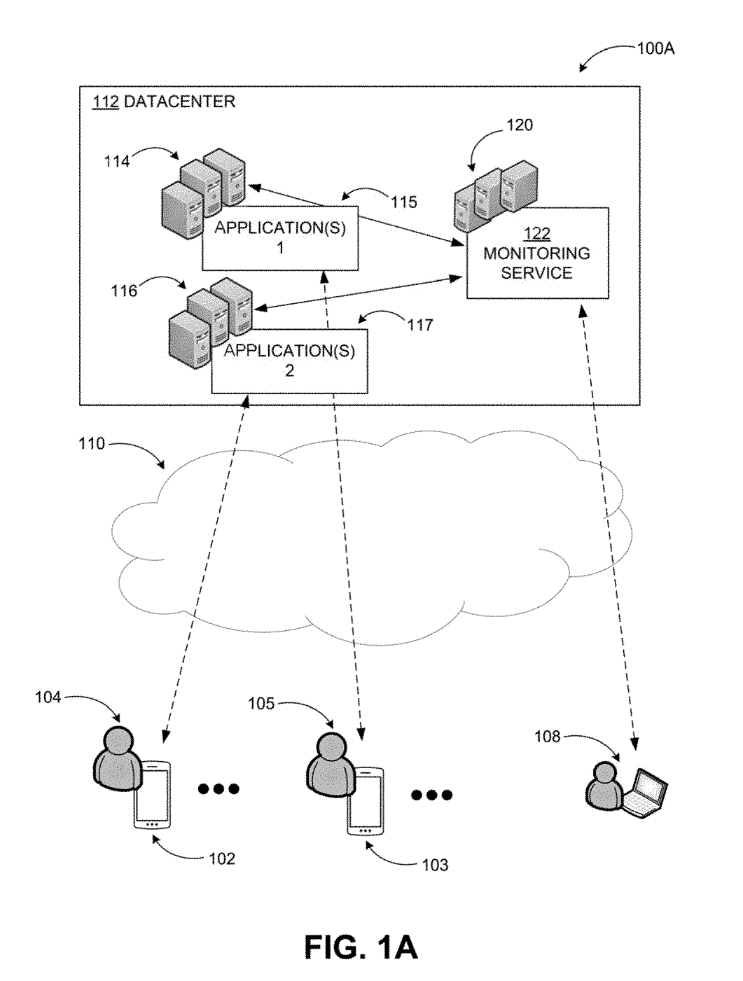

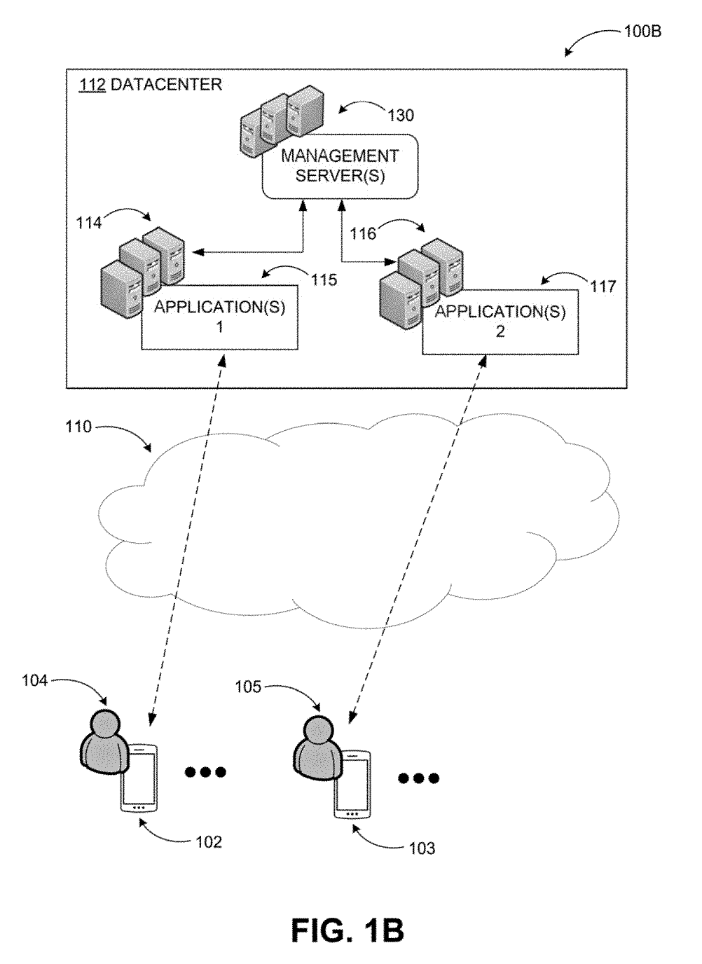

FIGS. 1A-1B include display diagrams illustrating example network environments where evaluation of server performance through a single value server performance index (SPI) may be implemented.

As illustrated in diagrams 100A-B, an example system may include a datacenter 112 hosting one or more cloud-based services. Applications hosted by the cloud-based services such as applications 115 and 117 may be executed on servers or server groups such as servers 114 and 116, respectively. The applications 115, 117, and their underlying hosted service(s) may be accessed by a number of users such as users 104, 105 through their respective client devices 102, 103. In one example scenario, the applications 115, 117 may be part of a productivity service such as a word processing application, a spreadsheet application, a presentation application, a communication application, and similar ones. The applications 115, 117 may be accessed by the users 104, 105 through thick (locally installed) or thin (browser) applications executed on client devices 102, 103.

A quality of service and accessibility of the applications 115, 117, as well as any other services provided by the cloud-based services may be subject to a number of operational aspects of the datacenter 112 and the networking environment. The applications 115, 117 may be executed in a distributed fashion on multiple servers or even on virtual servers, data may be exchanged, stored across multiple servers and data stores, network connections may have varying capacities, and so on. Thus, administrators of the cloud-based services may need to monitor a wide range of operational and configurational aspects to ensure acceptable quality of service and continued access to their service.

A monitoring service 122 executed on one or more servers 120 may monitor server and system operations of the servers 114, 116 according to some embodiments and compute a single value SPI. The single value SPI may be used to issue alerts to administrators, generate performance reports, or adjust server operations in response to changes in the SPI. An administrator 108 of the monitoring service 122 may configure the monitoring service 122 and manage collection of server data, computation of SPI, issuing of alerts, generation of reports, and adjustment of server operations and configurations.

Diagram 100B of FIG. 1B shows another example configuration of a system for evaluation of server performance through a single value SPI. In the example configuration, collection of server data, computation of SPI, issuing of alerts, generation of reports, and adjustment of server operations and configurations may be performed by a monitoring module or similar program executed at one or more of the management servers 130, which may also be tasked with managing operations of the servers 114, 116.

Some of the actions and/or processes described herein have been illustrated from the perspective of a server (for example, the servers 120 configured to execute the monitoring service 122), however similar actions may be performed similarly by a client, among other entities.

Technical advantages of evaluation of server performance through a single value SPI may include improved performance, reduced processing and network bandwidth usage, and improved user interaction, as well as enhanced server security and efficiency in distributed server systems.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with monitoring server performance across a variety of platforms and devices.

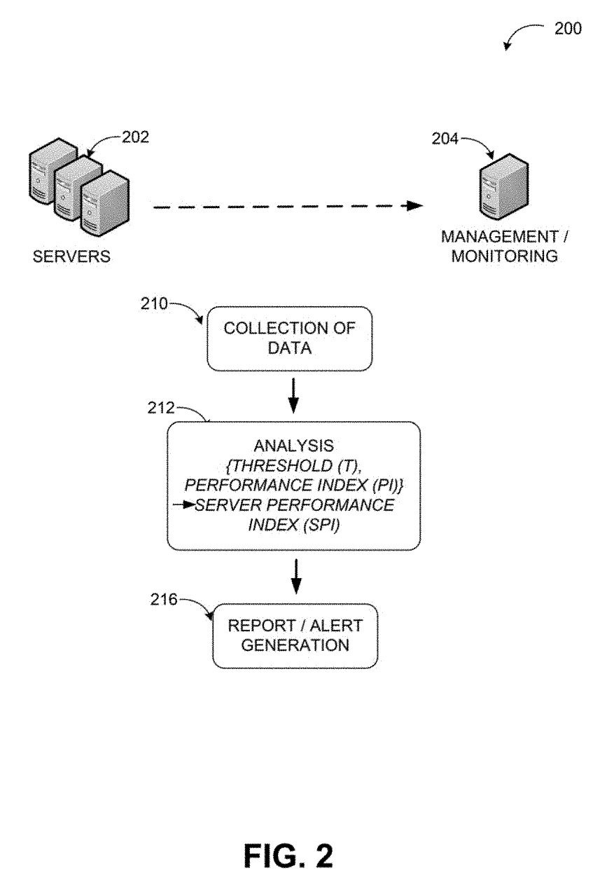

FIG. 2 includes a display diagram illustrating an example scheme to implement evaluation of server performance through a single value SPI up to report and/or alert generation phases.

As shown in diagram 200, servers 202 may be executing or providing ancillary services in execution of hosted services and applications. Server 204 may be a management server or a server executing a monitoring application or service to monitor performance of the servers 202. According to some embodiments, collection of data 210 may include gathering of performance related information from the servers 202. The information may be collected and transmitted by the applications/services executed on the servers 202 or collected and transmitted by one or more daemons or agents associated with the monitoring service. The information may be collected through sampling in some examples.

An analysis 212 may be performed on the collected data to determine an SPI as discussed herein. At a high level, the analysis may include determination of a threshold value for each performance dimension that identifies an average performance value over a predefined time period. Performance dimensions may include operational aspects such as memory usage, processor capacity usage, input/output usage, network bandwidth usage, latency, response time, virtualization level, and comparable parameters that may affect the executed service or application on the servers 202.

In one embodiment, the threshold may be defined as a maximum value of a corresponding performance dimension (e.g., memory usage). In another embodiment, the threshold may be defined as an average of the corresponding performance dimension over the predefined time period or a portion of it. For example, processor usage for a server may be measured as 50% over 90% of a 24-hour monitoring period. Thus, the threshold may be defined as 50%. Other determination approaches such as median value may also be used. The predefined time period may be selected based on server types, application types, available processing capacity for the monitoring and analysis, etc. Implementation examples may range from minutes to days or weeks.

Next, a performance index for a corresponding performance dimension may be determined based on a measured value of the corresponding performance dimension. In some embodiments, the performance index may be defined as the measured value of the corresponding performance dimension for a given time point divided by the threshold value (in other words, normalized). The performance index may be used as an absolute value or a percentage (multiplied by 100). For example, if the threshold for a server's processor capacity is 50% and a measured performance value is received as 40%, the resulting performance index may be 80%. In practical terms, the performance index may indicate what percentage of a typical or maximum performance is being measured at a given time point.

Determining the performance indices for monitored performance dimensions, the monitoring service or application may then determine the SPI for the monitored server (or group of servers) by combining the performance indices across the monitored performance dimensions. In one example, an average of the performance indices across the performance dimensions may be computed. Other combinations such as median, standard deviation, etc. may also be used to define the SPI.

An alert may be issued or a performance report generated (216) based on the SPI. Various alert parameters such as who should receive which alerts, what should the alert threshold be (SPI and/or individual performance indices), if different recipients should be alerted at different alert thresholds, etc. may be defined in the monitoring service and alerts issued based on those parameters. Similarly, content, format, recipients, frequency, etc. of the performance reports may be predefined or dynamically determined based on the SPI changes, for example.

Performance data may not only be received from servers, but also from other resources such as special purpose devices (e.g., firewalls, routers, etc.) at a datacenter. If the collected performance data is sampled, sampling frequency may be adjusted based on the SPI, in some examples. For example, if the SPI is fairly steady and within a desired range of operational parameters for a prolonged period of time, performance data sampling frequency may be reduced. On the other hand, if the SPI is volatile or close to a limit of the desired operational range, the sampling frequency may be increased.

In some embodiments, the performance indices may be assigned weights based on the type of the monitored performance dimension, desired operational outcome, executed service or application type, and other reasons. The weights may be adjusted based on the SPI or change of the SPI over time.

Servers 202 may execute any application or service, including, but not limited to, productivity services, virtualization services, scheduling services, collaborative services, communication services, and others. Additionally, the actions and/or processes described herein have been illustrated from the perspective of a server, however similar actions may be performed similarly by a client application, among other entities.

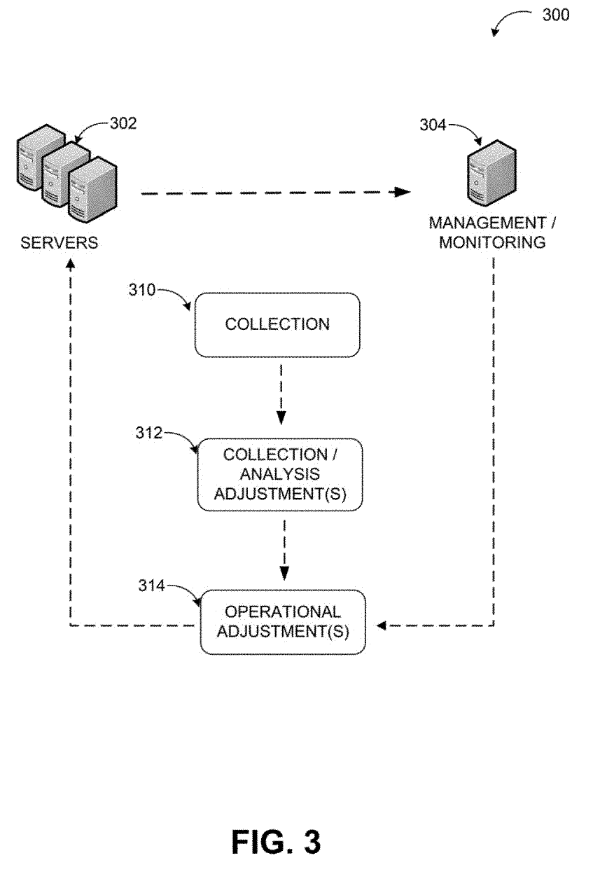

FIG. 3 includes a display diagram illustrating an example scheme to implement evaluation of server performance through a single value SPI including operational adjustment phases.

As shown in diagram 300, servers 302 may execute or provide ancillary services in execution of hosted services and applications. Server 304 may be a management server or a server executing a monitoring application or service to monitor performance of the servers 302. According to some embodiments, following the above-discussed performance data collection 310 and analysis (and/or data collection/analysis adjustment) 312 phases, a monitoring or management server may adjust operational parameters of the servers (314) instead of or in addition to the alert and report generation discussed above.

Operational parameters may be adjusted to modify the SPI or individual performance indices. Some of the adjustments may include, but are not limited to, taking a server offline, bringing a new server online, shifting processing load from a first server to a second server, changing a network connection, throttling assigned workload to one or more servers, and comparable ones.

The examples provided in FIG. 1A through FIG. 3 are illustrated with specific systems, services, applications, modules, and user experiences. Embodiments are not limited to environments according to these examples. Evaluation of server performance through a single value SPI may be implemented in environments employing fewer or additional systems, services, applications, modules, and user experiences. Furthermore, the example systems, services, applications, modules, and user experiences shown in FIG. 1A through FIG. 3 may be implemented in a similar manner with other values using the principles described herein.

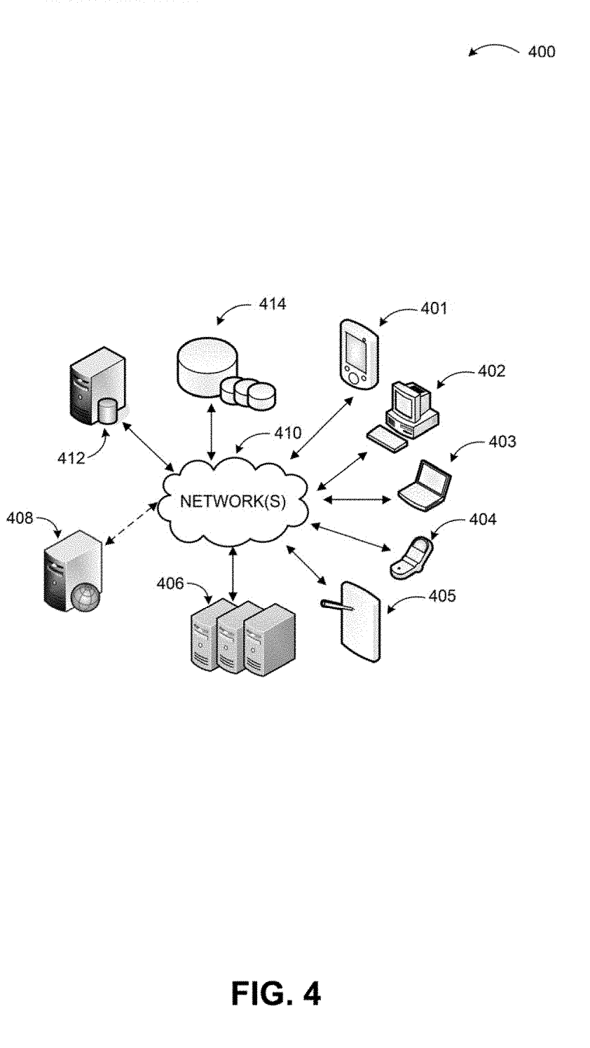

FIG. 4 is an example networked environment, arranged in accordance with at least some embodiments described herein.

In addition to locally installed applications, server performance evaluation may also be employed in conjunction with hosted applications and services (for example, a monitoring service 122) that may be implemented via software executed over one or more servers 406 or individual server 408, as illustrated in diagram 400. A hosted service or application may communicate with client applications on individual computing devices such as a handheld computer 401, a desktop computer 402, a laptop computer 403, a smart phone 404, a tablet computer (or slate), 404 (‘client devices’) through network(s) 410 and control a user interface presented to users.

Client devices 401-404 are used to access the functionality provided by the hosted service or application. One or more of the servers 406 or server 408 may be used to provide a variety of services as discussed above. Relevant data may be stored in one or more data stores (e.g. data store 414), which may be managed by any one of the servers 406 or by database server 412.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, engines, and modules may be employed to provide evaluation of server performance through a single value. Furthermore, the networked environments discussed in FIG. 4 are for illustration purposes only. Embodiments are not limited to the example services, applications, engines, modules or processes.

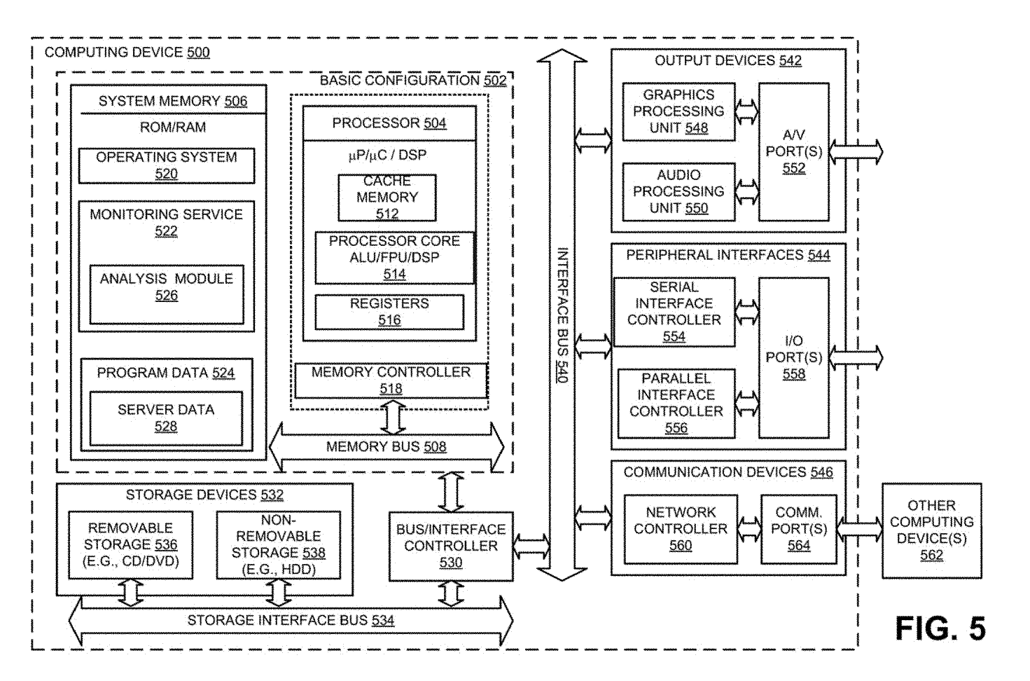

FIG. 5 illustrates a general purpose computing device, which may be configured to provide evaluation of server performance through a single value, arranged in accordance with at least some embodiments described herein.

For example, computing device 500 may be used as a server, desktop computer, portable computer, smart phone, special purpose computer, or similar device. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, one or more processor cores 514, and registers 516. The example processor cores 514 may (each) include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, a monitoring service 522, and program data 524. The monitoring service 522 may include an analysis module 526, which may be an integrated module of the monitoring service 522. The analysis module 526 may receive usage and health information associated with one or more server performance dimensions to be used in overall server performance evaluation. The analysis module 526 may then determine threshold value that identifies an average performance value for each dimension over a predefined time period for each dimension. The module may also determine a performance index for each dimension normalized by the corresponding threshold value. The SPI may be determined based on an averaging of the performance indices of the one or more dimensions. The monitoring service 522 may generate an alert or a report and/or adjust a server operation based on an evaluation of the SPI. The program data 524 may include, among other data, server data 528, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 505, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and one or more communication devices 546) to the basic configuration 502 via the bus/interface controller 530. Some of the example output devices 542 include a graphics processing unit 548 and an audio processing unit 550, which may be configured to communicate to various external devices such as a display or speakers via one or more A/V ports 552. One or more example peripheral interfaces 544 may include a serial interface controller 554 or a parallel interface controller 556, which may be configured to communicate with external devices such as input devices (for example, keyboard, mouse, pen, voice input device, touch input device, etc.) or other peripheral devices (for example, printer, scanner, etc.) via one or more I/O ports 558. An example communication device 546 includes a network controller 560, which may be arranged to facilitate communications with one or more other computing devices 562 over a network communication link via one or more communication ports 564. The one or more other computing devices 562 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods to provide evaluation of server performance through a single value. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pro-selected criteria that may be machine automated.

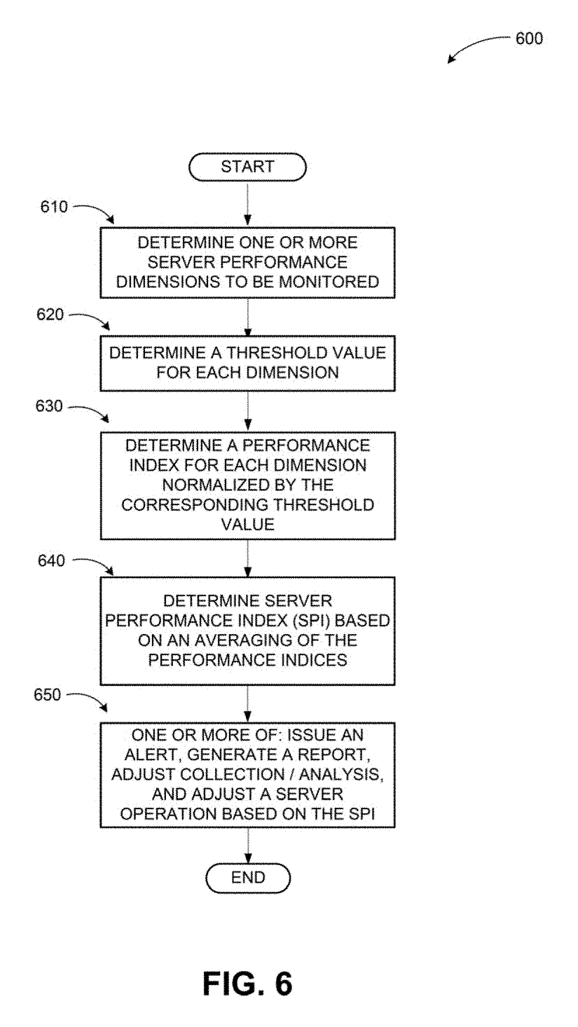

FIG. 6 illustrates a logic flow diagram for an example process to provide evaluation of server performance through a single value, arranged in accordance with at least some embodiments described herein.

Process 600 may be implemented on a computing device, server, or other system. An example system may include a communication interface configured to facilitate communication between a monitoring service and a number of servers in a system, a memory configured to store instructions, and one or more processors coupled to the memory and configured to execute an analysis module as part of the monitoring service, where the analysis module is configured to provide evaluation of server performance through a single value SPI.

Process 600 begins with operation 610, where one or more server performance dimensions to be used in overall server performance evaluation may be monitored. The dimensions may include server and system operational aspects such as memory usage, processor usage, bandwidth usage, input/output usage, response time, latency, and similar ones.

At operation 620, a threshold value that identifies an average performance value for each dimension over a predefined time period may be determined for each dimension. At operation 630, a performance index may be determined for each dimension normalized by the corresponding threshold value.

At operation 640, the SPI may be determined based on an averaging of the performance indices of the one or more dimensions. The SPI may then be used to issue an alert based on a predefined alert threshold, to generate a performance report, or to adjust a server operation by the monitoring service or another service receiving the SPI information from the monitoring service at operation 650.

The operations included in process 600 are for illustration purposes. Evaluation of server performance through a single value may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for providing evaluation of server performance through a single value server performance index (SPI) is described. The means may include a means for determining one or more server performance dimensions to be monitored; a means for receiving performance data associated with monitored server performance dimensions; for each server performance dimension, a means for determining a threshold value that identifies an average performance value over a predefined time period; for each server performance dimension, a means for determining a performance index normalized by a corresponding threshold value; a means for determining the SPI based on a combination of performance indices of the monitored server performance dimensions; and one or more of a means for issuing an alert, a means for generating a report, and a means for adjusting a server operation based on the SPI.

According to some examples, a method to provide evaluation of server performance through a single value server performance index (SPI) is described. The method may include determining one or more server performance dimensions to be monitored; receiving performance data associated with monitored server performance dimensions; for each server performance dimension, determining a threshold value that identifies an average performance value over a predefined time period; for each server performance dimension, determining a performance index normalized by a corresponding threshold value; determining the SPI based on a combination of performance indices of the monitored server performance dimensions; and one or more of issuing an alert, generating a report, and adjusting a server operation based on the SPI.

According to other examples, determining the performance index may include dividing received performance data for a server performance dimension by the corresponding threshold value. The method may also include converting the division to a percentage value. Determining the SPI based on the combination of the performance indices of the monitored server performance dimensions may include determining an average of the performance indices of the monitored server performance dimensions. Determining a threshold value for each server performance dimension may include determining a highest value of received performance data for each server performance dimension over the predefined time period.

According to further examples, the method may further include selecting the predefined time period based on the SPI. Receiving performance data associated with the monitored server performance dimensions may include receiving sampled performance data from a plurality of resources across datacenter. The method may further include adjusting a sampling frequency of the performance data associated with the monitored server performance dimensions based on the SPI. The method may also include adjusting the server operation based on a corresponding normalized performance index. The server performance dimensions may include one or more of: a memory usage, a processor usage, a network bandwidth usage, an input/output usage, a latency, a response time, and a virtualization level.

According to other examples, a computing device to provide evaluation of server performance through a single value server performance index (SPI) is described. The computing device may include a communication interface configured to facilitate communication between the computing device and one or more servers and other computing devices; a memory configured to store instructions; and one or more processors coupled to the memory and the communication interface, the one or more processors configured to execute a monitoring service. The monitoring service may be configured to determine one or more server performance dimensions to be monitored; receive collected performance data associated with monitored server performance dimensions; for each server performance dimension, determine a threshold value that identifies an average performance value over a predefined time period; for each server performance dimension, determine a performance index normalized by a corresponding threshold value; determine the SPI based on average of performance indices of the monitored server performance dimensions; and one or more of issue an alert, generate a report, and adjust a server operation based on one or more of the SPI and corresponding normalized performance index.

According to some examples, the monitoring service may be further configured to assign weights to received performance data based on a type of server performance dimension associated with each received performance data. The monitoring service may also be configured to assign weights to normalized performance indices based on a type of server performance dimension associated with each normalized performance index. The monitoring service may adjust the weights based on the SPI. The received performance data may include a performance value and a time of collection for each server performance dimension. The monitoring service may be part of a management service of a datacenter. The monitoring service may also be configured to monitor and determine SPIs for a plurality of datacenters.

According to further examples, a system to employ evaluation of server performance through a single value server performance index (SPI) is described. The system may include a plurality of servers configured to execute one or more hosted services and a management server. The management server may include a communication interface configured to facilitate communication between the computing device and one or more servers and other computing devices; a memory configured to store instructions; and one or more processors coupled to the memory and the communication interface, the one or more processors configured to execute a monitoring module. The monitoring module may be configured to determine one or more server performance dimensions to be monitored, where the one or more server performance dimensions include one or more of a memory usage, a processor usage, a network bandwidth usage, an input/output usage, a latency, a response time, and a virtualization level; receive collected performance data associated with monitored server performance dimensions; for each server performance dimension, determine a threshold value that identifies an average performance value over a predefined time period; for each server performance dimension, determine a performance index normalized by a corresponding threshold value; determine the SPI based on average of performance indices of the monitored server performance dimensions; and one or more of issue an alert, generate a report, and adjust a server operation based on one or more of the SPI and corresponding normalized performance index.

According to yet other examples, the monitoring module may be further configured to issue the alert based on the SPI and one or more alert thresholds to one or more designated entities. The monitoring module may also be configured to adjust the server operation by performing one or more of take a server offline, bring a new server online, shift processing load from a first server to a second server, change a network connection, and throttle assigned workload to one or more servers.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide evaluation of server performance through a single value server performance index (SPI), the method comprising:
determining one or more server performance dimensions to be monitored;
receiving performance data associated with monitored server performance dimensions;
for each server performance dimension, determining a threshold value that identifies an average performance value over a predefined time period;
for each server performance dimension, determining a performance index normalized by a corresponding threshold value;
determining the SPI based on a combination of performance indices of the monitored server performance dimensions; and
one or more of issuing an alert, generating a report, and adjusting a server operation based on the SPI.

2. The method of claim 1, wherein determining the performance index comprises:
dividing received performance data for a server performance dimension by the corresponding threshold value.

3. The method of claim 2, further comprising:
converting the division to a percentage value.

4. The method of claim 1, wherein determining the SPI based on the combination of the performance indices of the monitored server performance dimensions comprises:
determining an average of the performance indices of the monitored server performance dimensions.

5. The method of claim 1, wherein determining a threshold value for each server performance dimension comprises:
determining a highest value of received performance data for each server performance dimension over the predefined time period.

6. The method of claim 5, further comprising:
selecting the predefined time period based on the SPI.

7. The method of claim 1, wherein receiving performance data associated with the monitored server performance dimensions comprises:
receiving sampled performance data from a plurality of resources across datacenter.

8. The method of claim 7, further comprising:
adjusting a sampling frequency of the performance data associated with the monitored server performance dimensions based on the SPI.

9. The method of claim 1, further comprising:
adjusting the server operation based on a corresponding normalized performance index.

10. The method of claim 1, wherein the server performance dimensions include one or more of: a memory usage, a processor usage, a network bandwidth usage, an input/output usage, a latency, a response time, and a virtualization level.

11. A computing device to provide evaluation of server performance through a single value server performance index (SPI), the computing device comprising:
a communication interface configured to facilitate communication between the computing device and one or more servers and other computing devices;
a memory configured to store instructions; and
one or more processors coupled to the memory and the communication interface, the one or more processors configured to execute a monitoring service, wherein the monitoring service is configured to:
determine one or more server performance dimensions to be monitored;
receive collected performance data associated with monitored server performance dimensions;
for each server performance dimension, determine a threshold value that identifies an average performance value over a predefined time period;
for each server performance dimension, determine a performance index normalized by a corresponding threshold value;
determine the SPI based on average of performance indices of the monitored server performance dimensions; and
one or more of issue an alert, generate a report, and adjust a server operation based on one or more of the SPI and corresponding normalized performance index.

12. The computing device of claim 11, wherein the monitoring service is further configured to:
assign weights to received performance data based on a type of server performance dimension associated with each received performance data.

13. The computing device of claim 11, wherein the monitoring service is further configured to:
assign weights to normalized performance indices based on a type of server performance dimension associated with each normalized performance index.

14. The computing device of claim 13, wherein the monitoring service is further configured to:
adjust the weights based on the SPI.

15. The computing device of claim 10, wherein the received performance data includes a performance value and a time of collection for each server performance dimension.

16. The computing device of claim 11, wherein the monitoring service is part of a management service of a datacenter.

17. The computing device of claim 11, wherein the monitoring service is configured to monitor and determine SPIs for a plurality of datacenters.

18. A system to employ evaluation of server performance through a single value server performance index (SPI), the system comprising:
a plurality of servers configured to execute one or more hosted services; and
a management server comprising:
a communication interface configured to facilitate communication between the computing device and one or more servers and other computing devices;
a memory configured to store instructions; and
one or more processors coupled to the memory and the communication interface, the one or more processors configured to execute a monitoring module, wherein the monitoring module is configured to:
determine one or more server performance dimensions to be monitored, wherein the one or more server performance dimensions include one or more of a memory usage, a processor usage, a network bandwidth usage, an input/output usage, a latency, a response time, and a virtualization level;
receive collected performance data associated with monitored server performance dimensions;
for each server performance dimension, determine a threshold value that identifies an average performance value over a predefined time period;
for each server performance dimension, determine a performance index normalized by a corresponding threshold value;
determine the SPI based on average of performance indices of the monitored server performance dimensions; and
one or more of issue an alert, generate a report, and adjust a server operation based on one or more of the SPI and corresponding normalized performance index.

19. The system of claim 18, wherein the monitoring module is further configured to:
issue the alert based on the SPI and one or more alert thresholds to one or more designated entities.

20. The system of claim 18, wherein the monitoring module is configured to adjust the server operation by performing one or more of:
take a server offline, bring a new server online, shift processing load from a first server to a second server, change a network connection, and throttle assigned workload to one or more servers.
